(19) United States
(12) Patent Application Publication
(10) Pub. No.: US 2005/0281458 A1
(43) Pub. Date: Dec. 22, 2005

(54) Noise-reducing a color filter array image

(75) Inventors: James E. Adams JR., Rochester, NY (US); John F. Hamilton JR., Rochester, NY (US); Edward B. Gindele, Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/869,678

(22) Filed: Jun. 16, 2004

(51) Int. Cl. G06T 5/00

(52) U.S. Cl. 382/162; 382/260; 382/264; 382/275

(57) ABSTRACT

A method of reducing noise in a color filter array encoded image, comprising using an image sensor having a color filter array to capture an image of a scene and using such capture image to provide a color filter array encoded image; low pass filtering the color filter array encoded image to provide a base image and using such base image and the color filter array encoded image to provide a residual image; processing the base image to provide a full color fully processed base image; converting the residual image using color filter array interpolation to provide a full color residual image; and combining the full color fully processed base image and the full color residual image to provide a noised reduced fully processed image.

### CROSS REFERENCE TO RELATED APPLICATION

Reference is made to commonly-assigned U.S. patent application Ser. No. 09/742,957 filed Dec. 20, 2000, entitled “A Multiresolution Based Method for Removing Noise from Digital Images” by Gindele, the disclosure of which is incorporated herein.

### FIELD OF THE INVENTION

The invention relates generally to the field of digital image processing, and in particular to a method of noise-reducing digital camera images.

### BACKGROUND OF THE INVENTION

An essential step in most every digital camera image processing chain is noise-reduction. The prior art is rich with methods for accomplishing noise-reduction. Many, if not most, treat the problem generically as a task of noise-reduction of digital images, regardless of the source of said digital images. In this regard, it is not germane that the image was initially created by a digital camera. One class of inventions in this category uses a multiresolution (multi-scale) decomposition of the digital image, usually in the form of a Laplacian pyramid. This representation of the digital image generally permits effective noise-reduction of the digital image, both in terms of resulting image quality and required computational effort. For this reason, multiresolution noise-reduction methods are popular and many implementations exist. U.S. Pat. No. 5,488,374 (Frankot, et al.) teaches using a multi-scale adaptive filter for smoothing interferometric SAR data. U.S. Pat. No. 5,526,446 (Adelson, et al.) discloses converting an image into a set of coefficients in a multi-scale image decomposition process, and modifying the coefficients in order to reduce noise. U.S. Pat. No. 5,729,631 (Wober, et al.) reveals representing an image in a pyramid structure, using a Wiener variant filter to reduce noise in each pyramid level. U.S. Pat. No. 5,963,676 (Wu, et al.) describes a multi-scale approach that reduces noise using directional sensitive Laplacian kernels at each pyramid level. Above-cited commonly assigned U.S. patent application Ser. No. 09/742,597 (U.S. Patent Application Publication 2002/0118887) full color fully processed base image teaches decomposing an image into a multiresolution representation and noise-reducing in different ways the base and residual image components of the representation to achieve a noise-reduced final image.

All of these examples assume the initial image to be noise-reduced is in the same fundamental data representation as the final image to be produced by the subsequent full image processing chain, e.g., a full-color, three-channel RGB. In digital cameras, however, the initial image as produced by the camera sensor is usually a grayscale image into which color data is encoded with the use of a color filter array. The final image of the full image processing chain is a full-color, three-channel RGB image. The examples of multiresolution noise-reduction cited in the previous paragraph do not address the transformations required to accept a color filter array-encoded grayscale image upon input and to produce a noise-reduced full-color image upon output, particularly, as in the case of Gindele, when the base and residual image components go through different image processing paths. Noise-reduction theory indicates that the sooner in a sequence of image processing steps that the noise component can be removed from the image, the better will be the chances of performing effective noise-reduction without significant degradation of the genuine signal content of the image.

What is needed is a method of noise-reducing a digital camera image that accepts a color filter array-encoded grayscale image on input and produces a full-color fully processed image on output that permits a multiresolution decomposition of the image to be noise-reduced and separate processing paths for the base and residual image components. Any proposed solution should be independent of the nature of the color filter array encoding scheme used and the subsequent image processing steps used to fully process the image.

### SUMMARY OF THE INVENTION

It is the object of the present invention to provide an effective way to noise-reduce a digital camera image that accepts a color filter array-encoded grayscale image on input and produces a full-color fully processed image on output.

It is another object to permit a multiresolution decomposition of the image to be noise-reduced using separate processing paths for the base and residual image components.

This object is achieved by a method of reducing noise in a color filter array encoded image, comprising:
(a) using an image sensor having a color filter array to capture an image of a scene and using such capture image to provide a color filter array encoded image;
(b) low pass filtering the color filter array encoded image to provide a base image and using such base image and the color filter array encoded image to provide a residual image;
(c) processing the base image to provide a full color fully processed base image;
(d) converting the residual image using color filter array interpolation to provide a full color residual image; and
(e) combining the full color fully processed base image and the full color residual image to provide a noised reduced fully processed image.

It is an advantage of the present invention that it is independent of the nature of the color filter array encoding scheme used.

It is another advantage of the present invention that the noise-reduction ability is maximized by operating on the image at the earliest possible position within the image processing chain.

### BRIEF DESCRIPTION OF THE DRAWINGS

FIG. 1 is a perspective diagram of a computer system for implementing the present invention;

FIG. 2 is a diagram of the full image processing chain of the preferred embodiment of this invention;

FIG. 3 is a diagram of four example color filter array encoding schemes;

FIG. 4 is a diagram of the low pass filter operation;

FIG. 5 is a diagram of the Laplacian pyramid decomposition step;

FIG. 6 is a diagram of the Laplacian pyramid level decomposition step;

FIG. 7 is a diagram of the result of the downsample image operation;

FIG. 8 is a diagram of the cubic interpolation neighborhood used by the upsample image step;

FIG. 9A is a diagram of the noise-reduction of image components step for a base image component;

FIG. 9B is a diagram of the noise-reduction of image components step for a residual image component;

FIG. 10 is a diagram of the neighborhood used by the adaptive median filter;

FIG. 11 is a diagram of an neighborhood used by the standard sigma filter;

FIG. 12 is a diagram of the Laplacian pyramid recomposition step;

FIG. 13 is a diagram of the full image processing chain for an alternate embodiment of this invention;

FIG. 14 is a diagram of the full image processing chain for an alternate embodiment of this invention;

FIG. 15 is a diagram of the full image processing chain for an alternate embodiment of this invention;

FIG. 16 is a diagram of the full image processing chain for an alternate embodiment of this invention; and

FIG. 17 is a diagram of the full image processing chain for another alternate embodiment of this invention.

### DETAILED DESCRIPTION OF THE INVENTION

In the following description, a preferred embodiment of the present invention will be described in terms that would ordinarily be implemented as a software program. Those skilled in the art will readily recognize that the equivalent of such software can also be constructed in hardware. Because image manipulation arrangements and systems are well known, the present description will be directed in particular to algorithms and systems forming part of, or cooperating more directly with, the system and method in accordance with the present invention. Other aspects of such algorithms and systems, and hardware and/or software for producing and otherwise processing the image signals involved therewith, not specifically shown or described herein, can be selected from such systems, algorithms, components and elements known in the art. Given the system as described according to the invention in the following materials, software not specifically shown, suggested or described herein that is useful for implementation of the invention is conventional and within the ordinary skill in such arts.

Still further, as used herein, the computer program can be stored in a computer readable storage medium, which can include, for example; magnetic storage media such as a magnetic disk (such as a hard drive or a floppy disk) or magnetic tape; optical storage media such as an optical disc, optical tape, or machine readable bar code; solid state electronic storage devices such as random access memory (RAM), or read only memory (ROM); or any other physical device or medium employed to store a computer program.

Before describing the present invention, it facilitates understanding to note that the present invention is preferably utilized on any well-known computer system, such as a personal computer. Consequently, the computer system will not be discussed in detail herein. It is also instructive to note that the images are either directly input into the computer system (for example by a digital camera) or digitized before input into the computer system (for example by scanning an original, such as a silver halide film).

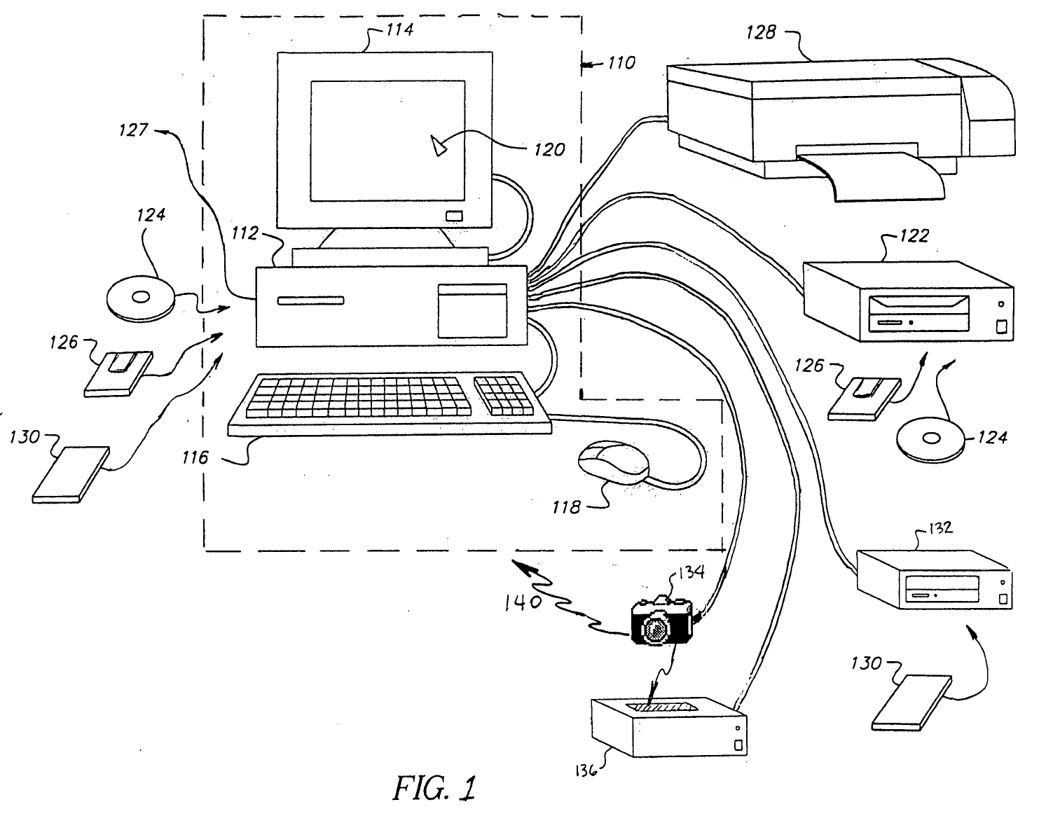

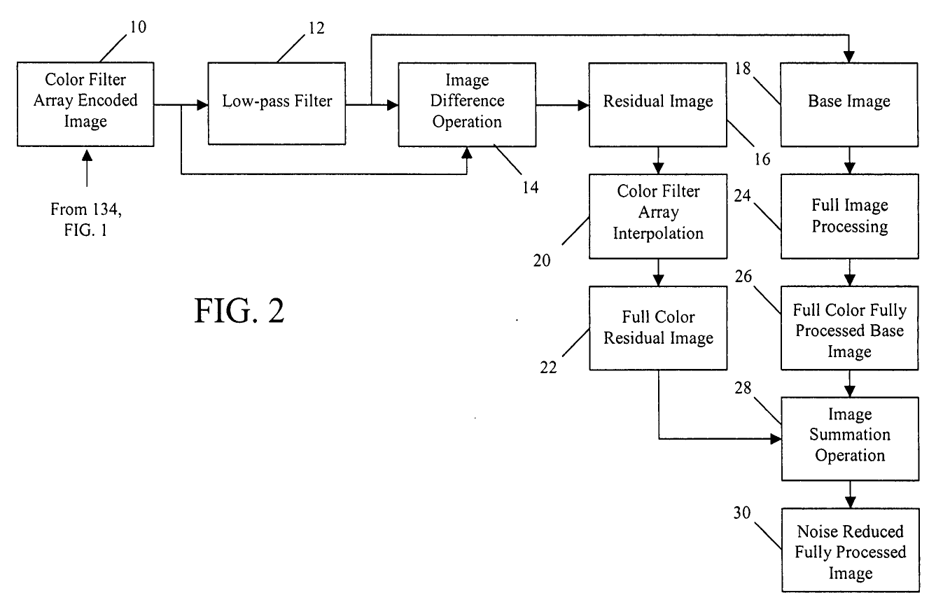

Referring to FIG. 1, there is illustrated a computer system 110 for implementing the present invention. Although the computer system 110 is shown for the purpose of illustrating a preferred embodiment, the present invention is not limited to the computer system 110 shown, but can be used on any electronic processing system such as found in home computers, kiosks, retail or wholesale photofinishing, or any other system for the processing of digital images. The computer system 110 includes a microprocessor-based unit 112 for receiving and processing software programs and for performing other processing functions. A display 114 is electrically connected to the microprocessor-based unit 112 for displaying user-related information associated with the software, e.g., by means of a graphical user interface. A keyboard 116 is also connected to the microprocessor based unit 112 for permitting a user to input information to the software. As an alternative to using the keyboard 116 for input, a mouse 118 can be used for moving a selector 120 on the display 114 and for selecting an item on which the selector 120 overlays, as is well known in the art.

A compact disk-read only memory (CD-ROM) 124, which typically includes software programs, is inserted into the microprocessor-based unit 112 for providing a means of inputting the software programs and other information to the microprocessor based unit 112. In addition, a floppy disk 126 can also include a software program, and is inserted into the microprocessor-based unit 112 for inputting the software program. The compact disk-read only memory (CD-ROM) 124 or the floppy disk 126 can alternatively be inserted into an externally located disk drive unit 122 which is connected to the microprocessor-based unit 112. Still further, the microprocessor-based unit 112 can be programmed, as is well known in the art, for storing the software program internally. The microprocessor-based unit 112 can also have a network connection 127, such as a telephone line, to an external network, such as a local area network or the Internet. A printer 128 can also be connected to the microprocessor-based unit 112 for printing a hardcopy of the output from the computer system 110.

Images can also be displayed on the display 114 via a personal computer card (PC card) 130, such as, as it was formerly known, a PCMCIA card (based on the specifications of the Personal Computer Memory Card International Association) which contains digitized images electronically embodied in the PC card 130. The PC card 130 is ultimately inserted into the microprocessor-based unit 112 for permitting visual display of the image on the display 114. Alternatively, the PC card 130 can be inserted into an externally located PC card reader 132 connected to the microprocessor-based unit 112. Images can also be input via the compact disk 124, the floppy disk 126, or the network connection 127. Any images stored in the PC card 130, the floppy disk 126 or the compact disk 124, or input through the network connection 127, can have been obtained from a variety of sources, such as a digital camera 134 or a scanner (not shown). Images can also be input directly from the digital camera 134 via a camera docking port 136 connected to the microprocessor-based unit 112 or directly from the digital camera 134 via a cable connection 138 to the microprocessor-based unit 112 or via a wireless connection 140 to the microprocessor-based unit 112.

In accordance with the invention, the programs embodying the present invention can be stored in any of the storage devices heretofore mentioned and applied to images in order to construct a noise-reduced image.

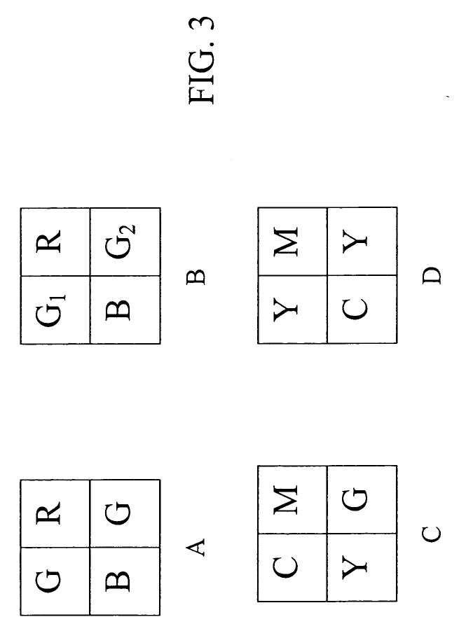

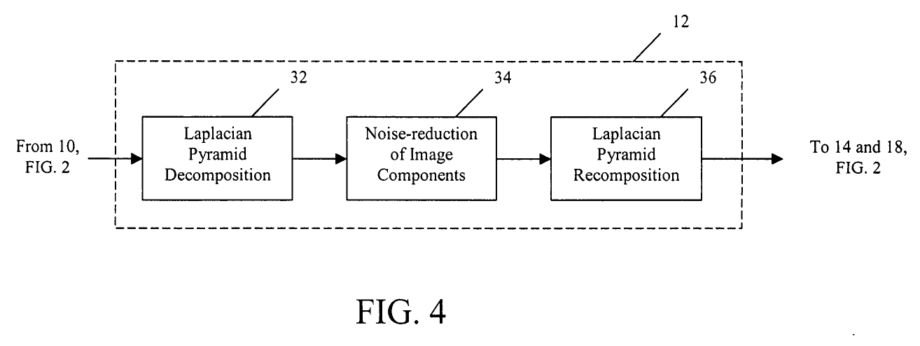

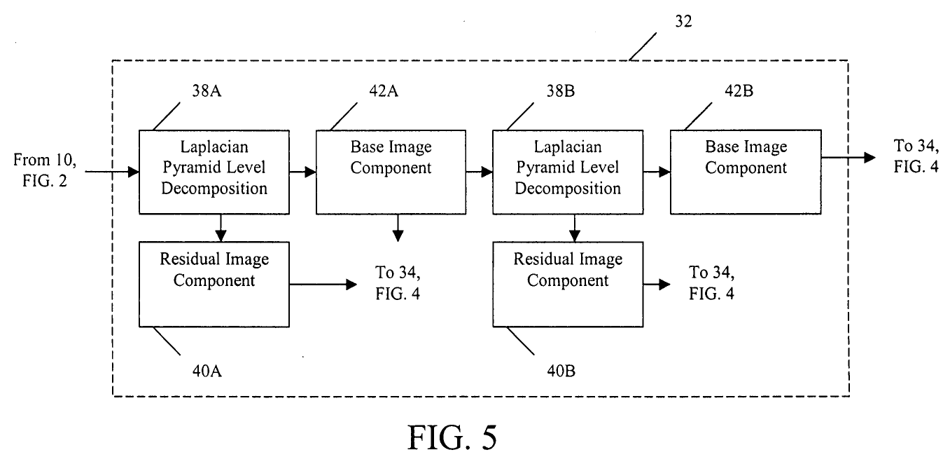

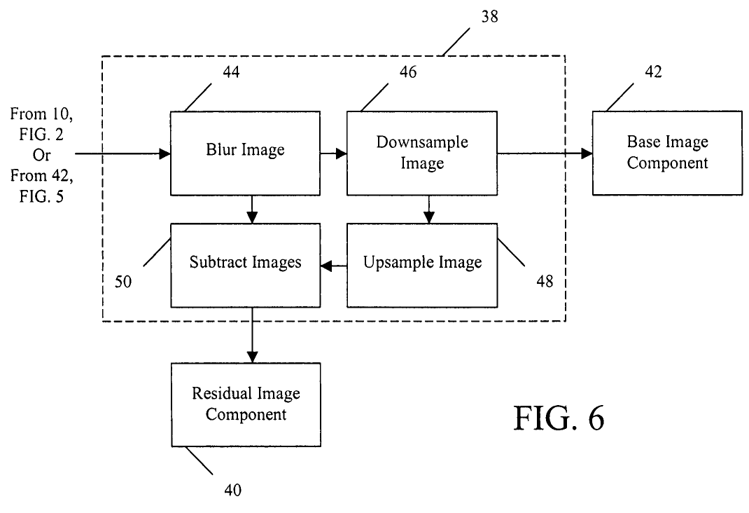

FIG. 2 is a block diagram of the image processing chain that is the preferred embodiment of this invention. The color filter array encoded image 10 is acquired by the digital camera 134, FIG. 1 and provides selected pixel patterns. A copy of the color filter array encoded image 10 is low pass filtered by low pass filter operation 12. The result of the low pass filter operation 12 is the base image 18 of this embodiment. The base image 18 is subtracted from a copy of the original color filter array encoded image 10 in the image difference operation step 14. The result of the image difference operation is the residual image 16 of this embodiment. The residual image 16 is still in a color filter array encoded representation. The color filter array interpolation step 20 creates a full color residual image 22. The full image processing step 24 performs the standard image processing operations associated with digital camera image processing chain, such as, but not limited to, color filter array interpolation, color and tone correction, and sharpening, to the base image 18. The result of the full image processing 24 is a fully processed base image 26. The full color residual image 22 and the fully processed base image 26 are added together in the image summation operation 28. The result of the image summation operation 28 is a full color fully processed image 30. The full color fully processed image 30 is the resulting noise-reduced image created by this embodiment of this invention.

The nature of the color filter array encoding is unimportant for this invention. FIG. 3 shows four examples of color filter array encoding that are compatible with the current invention. In FIG. 3, encoding A represents a three-color tessellation kernel with R, G, and B denoting red, green, and blue. In encoding B, a four-color tessellation kernel is shown with R, G₁, G₂, and B denoting red, a first shade of green, a second shade of green, and blue. In encoding C, a four-color tessellation kernel in shown with C, M, Y, and G denoting cyan, magenta, yellow, and green. In encoding D, a three-color tessellation kernel is shown with C, M, and Y denoting cyan, magenta, and yellow. It will be evident to one skilled in the art that other color filter array encoding schemes are possible.

The nature of the low pass filtering operation 12 in FIG. 2 can be the application of a simple convolution kernel such as

$$\frac{1}{16} ( \begin{matrix}1 & 2 & 1 \\ 2 & 4 & 2 \\ 1 & 2 & 1\end{matrix} )$$

or can take the form of a noise cleaning operation such as a median filter and/or a sigma filter. Regardless of its nature, the low pass filtering operation 12 must perform its actions with respect to the color filter array encoding used. This usually means restricting any given computation to one specific set of colors within the encoding. Returning to the previously cited simple convolution kernel, the variation that would work for any of the encodings presented in FIG. 3 would be

$$\frac{1}{16} ( \begin{matrix}1 & 0 & 2 & 0 & 1 \\ 0 & 0 & 0 & 0 & 0 \\ 2 & 0 & 4 & 0 & 2 \\ 0 & 0 & 0 & 0 & 0 \\ 1 & 0 & 2 & 0 & 1\end{matrix} )$$

Regardless of where this convolution kernel is placed in the color filter array image, the nonzero coefficients will always correspond to the same color within the encoding. Convolving the color filter array encoded image 10 with this kernel will produce a low pass filtered version of the color filter array encoded image that still maintains the color encoding integrity of the encoding scheme. If other operations, such as median and/or sigma filters are used instead of this convolution kernel, they must be similarly modified to retain the integrity of the color encoding scheme.

In the preferred embodiment, the details of the low pass filtering operation 12 are depicted in FIG. 4. The color filter array encoded image 10 is decomposed into a Laplacian pyramid representation by the Laplacian pyramid decomposition step 32. The noise-reduction of image components operation 34 noise-reduces the residual image components of the Laplacian pyramid representation, as well as the lowest-resolution base image component of the Laplacian pyramid representation. The Laplacian pyramid recomposition step 36 reconstitutes a full-resolution image using the noise-reduced components produced by the noise-reduction of image components operation 34.

In FIG. 5, the Laplacian pyramid decomposition step 32 is presented in more detail. The color filter array encoded image 10, FIG. 2, is decomposed into a residual image component 40A and a base image component 42A by the Laplacian pyramid level decomposition step 38A. Using the base image component 42A as input, this process is repeated in blocks 38B, 40B, and 42B to create second level of pyramid decomposition. FIG. 5 explicitly shows the creation of two pairs of residual and base image component. It should be evident to one skilled in the art that this process can be repeated as many times as desired to create pyramid composition consisting of more than two levels.

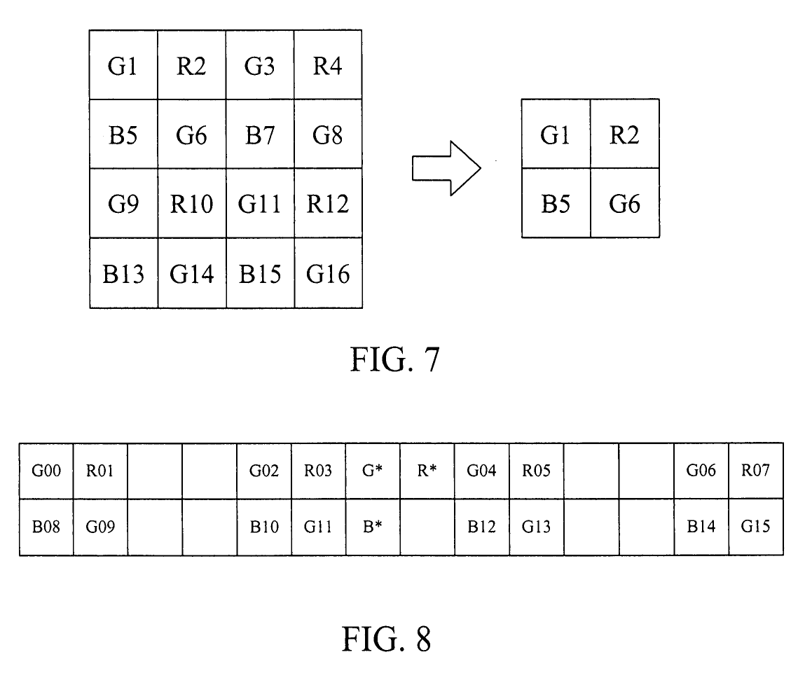

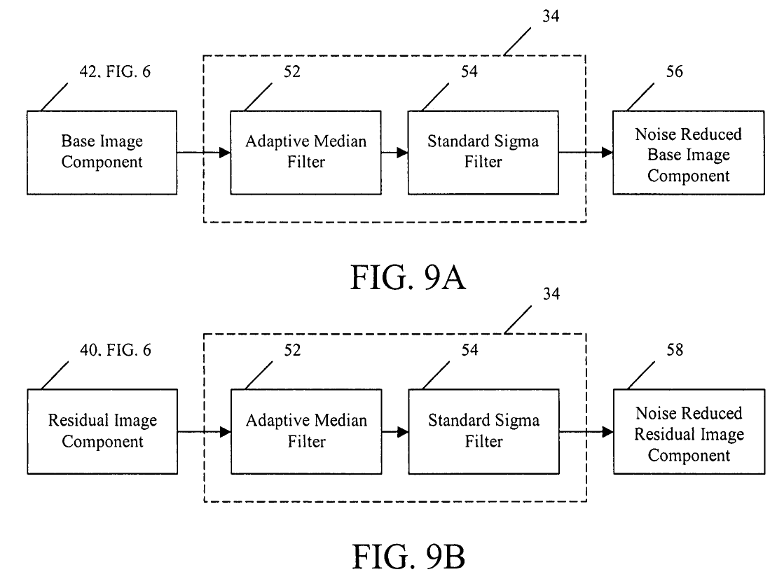

In FIG. 6, the Laplacian pyramid level decomposition step 38 is presented in more detail. The color filter array encoded image 10, FIG. 2, or a base image component 42, FIG. 5, is blurred in the blur image step 44 using the following convolution kernel:

$$\frac{1}{256} ( \begin{matrix}1 & 0 & 4 & 0 & 6 & 0 & 4 & 0 & 1 \\ 0 & 0 & 0 & 0 & 0 & 0 & 0 & 0 & 0 \\ 4 & 0 & 16 & 0 & 24 & 0 & 16 & 0 & 4 \\ 0 & 0 & 0 & 0 & 0 & 0 & 0 & 0 & 0 \\ 6 & 0 & 24 & 0 & 36 & 0 & 24 & 0 & 6 \\ 0 & 0 & 0 & 0 & 0 & 0 & 0 & 0 & 0 \\ 4 & 0 & 16 & 0 & 24 & 0 & 16 & 0 & 4 \\ 0 & 0 & 0 & 0 & 0 & 0 & 0 & 0 & 0 \\ 1 & 0 & 4 & 0 & 6 & 0 & 4 & 0 & 1\end{matrix} )$$

The downsample image step 46 discards alternate pairs of rows and columns of the blurred image to reduce the image resolution to half of its starting resolution. FIG. 7 shows the results of the downsample image step 46 on a 4×4 region of the color filter array encoded image 10. Though the encoding scheme of FIG. 3, encoding scheme A is shown in FIG. 7, all of the encoding schemes shown in FIG. 3 would be treated in the same manner. The result of the downsample image step 46 is a base image component 42. To continue the discussion of the Laplacian pyramid level decomposition step 38, a copy of the base image component 42 is upsampled in the upsample image step 48. In the preferred embodiment a standard bicubic interpolation, modified to respect the color filter array encoding of the image data, is used to double the resolution of the image. FIG. 8 is a portion of the upsampled image with blanks inserted at the locations that will be populated by the upsample image step 48. The computation of example values R*, G*, and B* are performed with the following cubic interpolation equations:
R*=(−R01+9R03+9R05−R07)/16
G*=(−G00+9G02+9G04−G06)/16
B*=(−B08+9B10+9B12−B14)/16
By using these equations and their vertically-oriented equivalents, the entire image is upsampled in a way that respects the color filter array encoding. Though the encoding scheme A of FIG. 3 is shown in FIG. 8, all of the encoding schemes shown in FIG. 3 would be treated in the same manner.

The results of the blur image 44 and upsample image 48 steps are subtracted from each other in the subtract images step 50. The result of the subtract images step 50 is the residual image component 40.

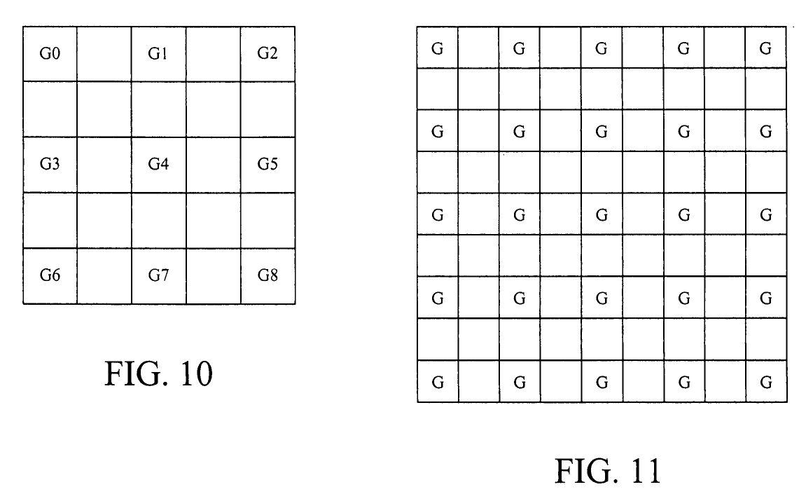

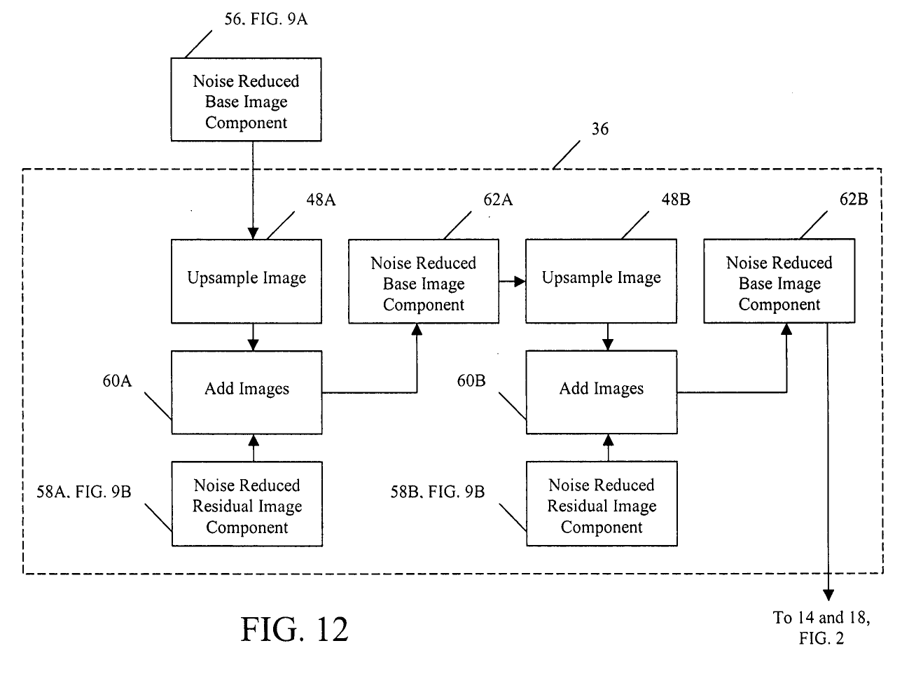

Returning to FIG. 4, the residual image components 40 and the lowest resolution base image component 42 (42B in FIG. 5) are noise-reduced in the noise-reduction of image components step 34. FIGS. 9A and 9B show the noise-reduction of image components step 34 in more detail. In the preferred embodiment, this noise-reduction takes the form of an adaptive median filter 52 followed by a standard sigma filter 54. In FIG. 9A the lowest resolution base image component 42 (42B in FIG. 5) is noise-reduced to produce a noise reduced base image component 56. In FIG. 9B a residual image component 40 is noise-reduced to produce a noise-reduced residual image component 5. FIG. 10 show a 3×3 portion of the residual image components 40 and the lowest resolution base image component 42 to be noise-reduced by the adaptive median filter 52. Four medians are computed in four different directions within the region:
h=median{G3,G4,G5}
v=median{G1,G4,G7}
s=median{G2,G4,G6}
b=median{G0,G4,G8}
From this set of four median values, the value that is closest to the original pixel value G4 becomes the noise-reduced pixel value for G4. This process is performed for all pixel values in the image component being noise-reduced. The region used by the subsequent standard sigma filter 54 for computation is shown in FIG. 11. Only the values from the pixels labeled “G” are used by the sigma filter. In all other respects, the sigma filter operation is standard. The adaptive median and sigma filter operations as described here will work for all of the encoding schemes shown in FIG. 3.

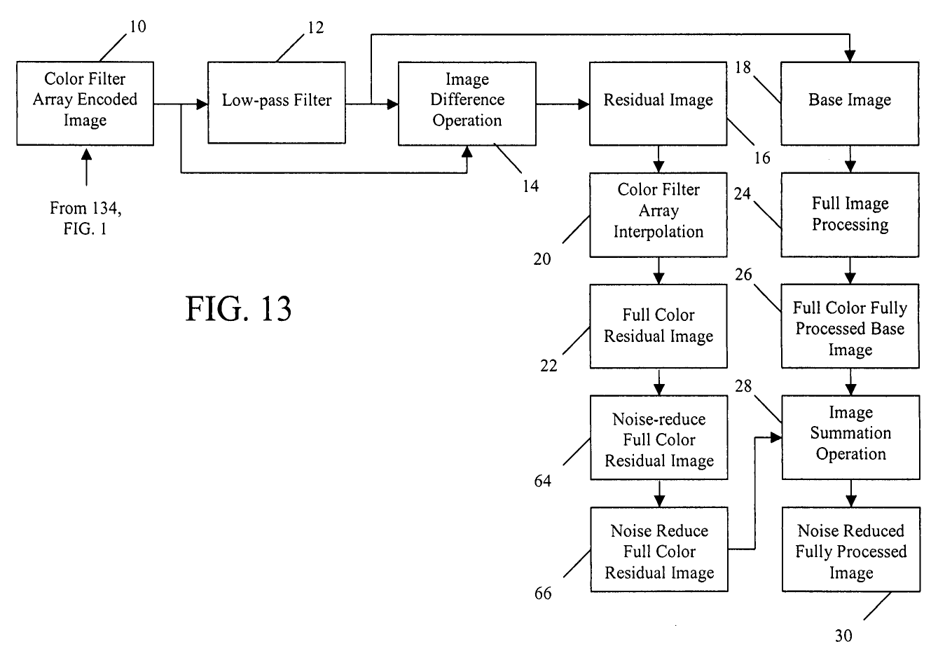

Returning to FIG. 4, the noise cleaned image components 56 and 58 are used by the Laplacian pyramid recomposition step 36 to produce the base image 18, FIG. 2. FIG. 12 shows the Laplacian pyramid recomposition step 36 in more detail. The noise-reduced base image component 56, FIG. 9A is upsampled by a factor of two by the upsample image operation 48A, previously described in conjunction with FIG. 8. The upsampled noise-reduced base image component is added to the lowest resolution noise-reduced residual image component 58A, FIG. 9B (derived from residual image component 40B, FIG. 5) in the add images step 60A. The result of the add images step 60A is the noise-reduced base image component 62A. It is noted that noise-reduced base image component 62A has twice the number of rows and columns as noise-reduced base image component 56. This process is repeated in blocks 48B, 60B, and 58B to produce noise-reduced base image component 62B. Noise-reduced base image component 62B, in turn, become base image 18. As in the discussion of FIG. 5, it should be evident to one skilled in the art that while FIG. 12 only shows a two-level pyramid reconstruction process, the method can be directly extended to a pyramid with more levels. The only constraint is that FIG. 5 and FIG. 12 must work with the same number of pyramid levels.

The color filter array interpolation step 20, FIG. 2, generally can be any color filter array interpolation method known to one skilled in the art. Such a method suitable for all of the color filter array encodings shown in FIG. 3 is described in U.S. Pat. No. 6,133,953 (Okada).

FIG. 13 is an alternate embodiment of this invention in which the full color residual image 22 is noise-reduced by a noise-reduced full color residual image operation 64 so as to create a noise-reduced full color image 66 prior to image summation operation 28. The noise-reduced full color residual image operation 64 is similar to the low pass filter operation 12 except there is no longer a need to respect the color filter array encoding scheme used in creating the color filter array encoded image 10. That being said, it is still possible to use the exact form of the low pass filter operation 12 for the noise-reduced full color residual image operation 64, and in the case of noise-reducing an extremely noisy image it is the preferred approach. It should be evident to one skilled in the art that some or all of the color filter array encoding specific operations of the low pass filter operation 12 can be replaced with equivalent standard full-color operations in the noise-reduced full color residual image operation 64.

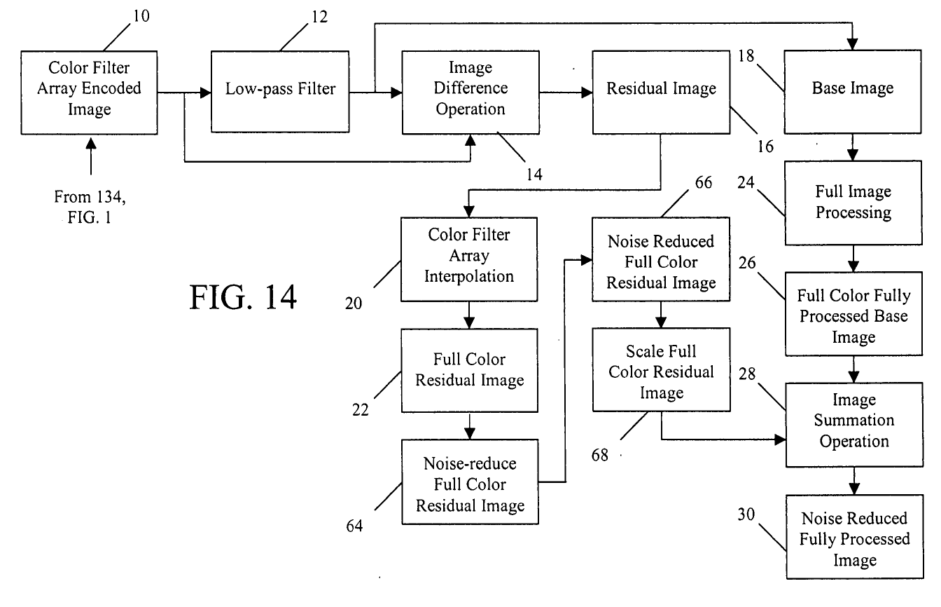

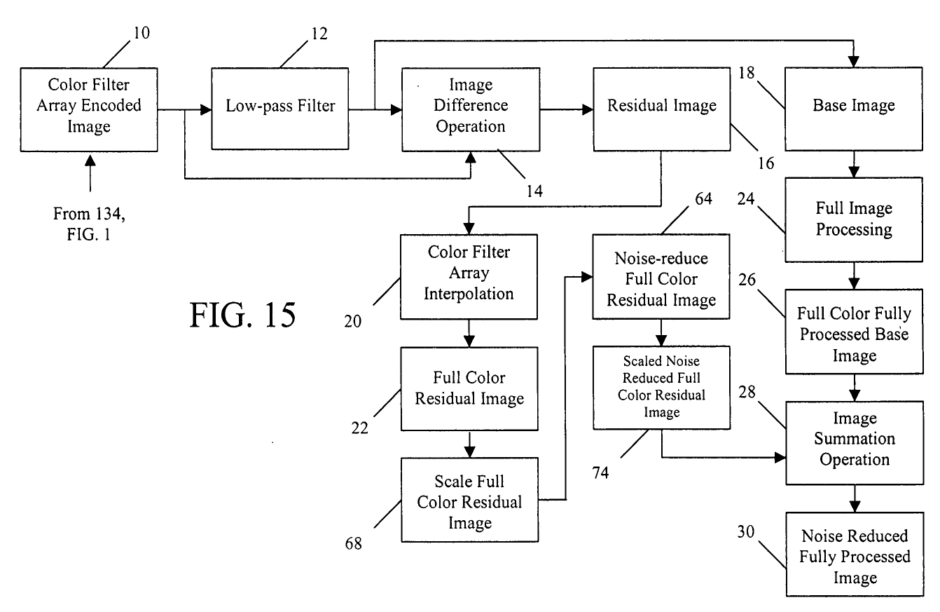

FIG. 14 is an alternative embodiment of this invention in which the noise-reduced full color residual image 66 is scaled in a scale full color residual image step 68 prior to the image summation operation 28. The scale full color residual image operation 68 is a simple multiplicative scaling of all the pixel values in the noise-reduced full-color residual image 66. Typically, a scale factor of 3.0 produces increased sharpness in the full color fully processed image 30 without significant loss of image quality due to amplification of the remaining noise in the noise-reduced full-color residual image 66.

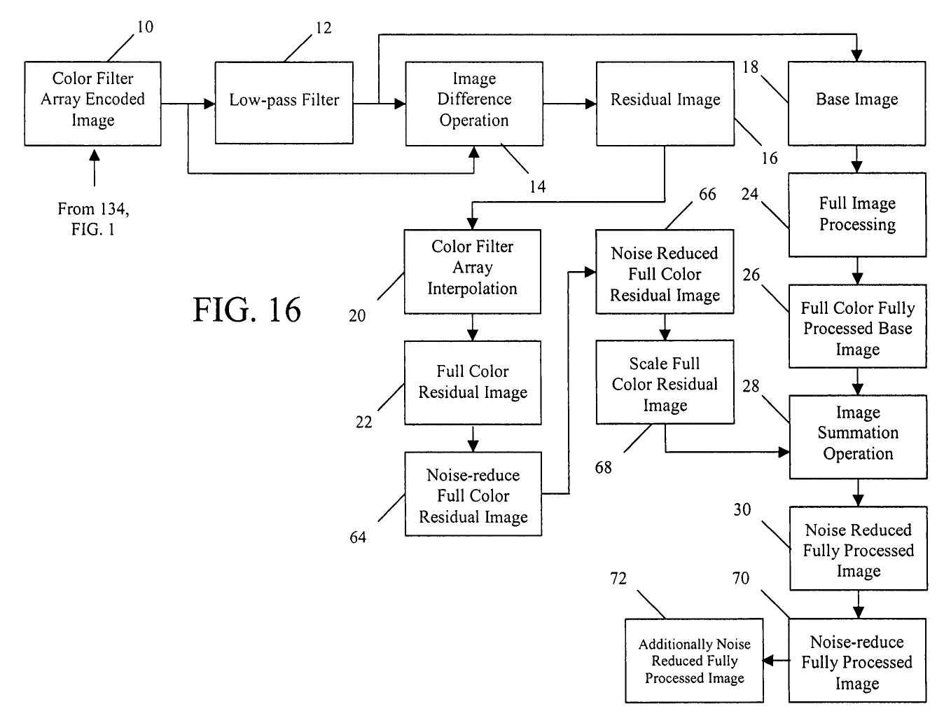

FIG. 15 is an alternative embodiment of this invention in which the full color residual image 22 is scaled in the scale full color residual image step 68 prior to the noise-reduced full color residual image step 64. The result is a scaled noise-reduced full color residual 74. As described in the previous embodiment, a scale factor of 3.0 produces increased sharpness in the full color fully processed image 30 without significant loss of image quality due to amplification of the remaining noise in the noise-reduced full-color residual image 66.

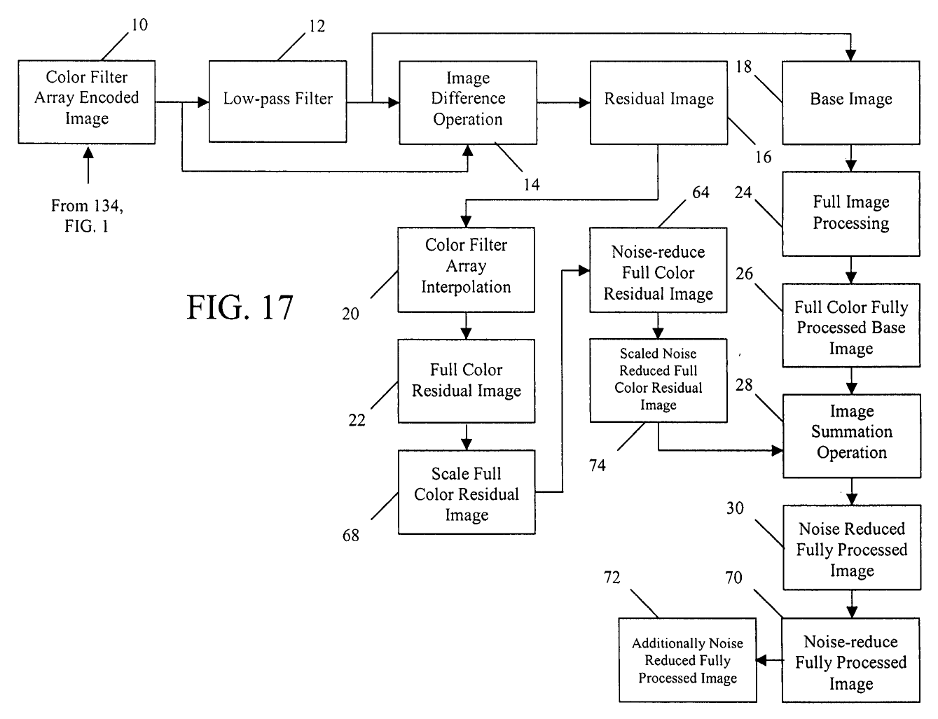

FIG. 16 is an alternative embodiment of this invention, based on the alternative embodiment of FIG. 14, in which full color fully processed image 30 is noise-reduced by the noise-reduced fully processed image step 70 to produce an additionally noise-reduced fully processed image 72. The details of the noise-reduced fully processed image step 70 are identical to the noise-reduced full color residual image operation 64, including the decision to use color filter array encoding specific operations versus standard full-color operations.

FIG. 17 is another alternative embodiment of this invention, based on the alternative embodiment of FIG. 15, in which full color fully processed image 30 is noise-reduced by the noise-reduced fully processed image step 70 to produce an additionally noise-reduced fully processed image 72. The details of the noise-reduced fully processed image step 70 are identical to the noise-reduce full color residual image operation 64, including the decision to use color filter array encoding specific operations versus standard full-color operations.

The specific algorithms disclosed in the preferred embodiments of the present invention can be employed in a variety of user contexts and environments. Exemplary contexts and environments include, without limitation, wholesale digital photofinishing (which involves exemplary process steps or stages such as film in, digital processing, prints out), retail digital photofinishing (film in, digital processing, prints out), home printing (home scanned film or digital images, digital processing, prints out), desktop software (software that applies algorithms to digital prints to make them better—or even just to change them), digital fulfillment (digital images in—from media or over the web, digital processing, with images out—in digital form on media, digital form over the web, or printed on hard-copy prints), kiosks (digital or scanned input, digital processing, digital or scanned output), mobile devices (e.g., PDA or cell phone that can be used as a processing unit, a display unit, or a unit to give processing instructions), and as a service offered via the World Wide Web.

In each case, the program to produce noise-reduced images can stand alone or can be a component of a larger system solution. Furthermore, the interfaces with the program, e.g., the scanning or input, the digital processing, the display to a user (if needed), the input of user requests or processing instructions (if needed), the output, can each be on the same or different devices and physical locations, and communication between the devices and locations can be via public or private network connections, or media based communication. Where consistent with the foregoing disclosure of the present invention, the algorithm(s) themselves can be fully automatic, can have user input (be fully or partially manual), can have user or operator review to accept/reject the result, or can be assisted by metadata (metadata that can be user supplied, supplied by a measuring device (e.g. in a camera), or determined by an algorithm). Moreover, the program(s) can interface with a variety of workflow user interface schemes.

The algorithms to produce noise-reduced images disclosed herein in accordance with the invention can have interior components that utilize various data detection and reduction techniques (e.g., face detection, eye detection, skin detection, flash detection)

The invention has been described in detail with particular reference to certain preferred embodiments thereof, but it will be understood that variations and modifications can be effected within the spirit and scope of the invention.

### PARTS LIST

10 Color Filter Array Encoded Image
12 Low pass Filter
14 Image Difference Operation
16 Residual Image
18 Base Image
20 Color Filter Array Interpolation
22 Full Color Residual Image
24 Full Image Processing
26 Fully Processed Base Image
28 Image Summation Operation
30 Full Color Fully Processed Image
32 Laplacian Pyramid Decomposition
34 Noise-reduction of Image Components
36 Laplacian Pyramid Recomposition
38 Laplacian Pyramid Level Decomposition
38A Laplacian Pyramid Level Decomposition
38B Laplacian Pyramid Level Decomposition
40 Residual Image Component
40A Residual Image Component
40B Residual Image Component
42 Base Image Component
42A Base Image Component
42B Base Image Component
44 Blur Image
46 Downsample Image
48 Upsample Image
48A Upsample Image
48B Upsample Image
50 Subtract Images
52 Adaptive Median Filter
54 Standard Sigma Filter
56 Noise-reduced Base Image Component
58 Noise-reduced Residual Image Component
58A Noise-reduced Residual Image Component
58B Noise-reduced Residual Image Component
60A Add Images
60B Add Images
62A Noise-reduced Base Image Component
62B Noise-reduced Base Image Component
64 Noise-reduced Full Color Residual Image Operation
66 Noise-reduced Full Color Residual Image
68 Scale Full Color Residual Image
70 Noise-reduce Fully Processed Image
72 Additionally Noise-reduced Fully Processed Image
74 Scaled Noise-reduced Full Color Residual
110 Computer System
112 Microprocessor-based Unit
114 Display
116 Keyboard
118 Mouse
120 Selector on Display
122 Disk Drive Unit
124 Compact Disk—read Only Memory (CD-ROM)
126 Floppy Disk
127 Network Connection
128 Printer
130 Personal Computer Card (PC card)
132 PC Card Reader
134 Digital Camera
136 Camera Docking Port
138 Cable Connection
140 Wireless Connection

1. A method of reducing noise in a color filter array encoded image, comprising:
(a) using an image sensor having a color filter array to capture an image of a scene and using such capture image to provide a color filter array encoded image;
(b) low pass filtering the color filter array encoded image to provide a base image and using such base image and the color filter array encoded image to provide a residual image;
(c) processing the base image to provide a full color fully processed base image;
(d) converting the residual image using color filter array interpolation to provide a full color residual image; and
(e) combining the full color fully processed base image and the full color residual image to provide a noised reduced fully processed image.

2. The method of claim 1 wherein the low pass filtering includes Laplacian pyramid decomposition, noise-reduction of image components and Laplacian pyramid recomposition.

3. The method of claim 1 wherein the low pass filtering includes using a convolution kernel.

4. The method of claim 1 wherein the low pass filtering includes noise cleaning.

5. The method of claim 1 wherein the color filter array encoded image provides selected pixel patterns.

6. The method of claim 1 further including noise-reducing the full color residual image to produce a noise-reduced full color residual image.

7. The method of claim 1 further including scaling the noise-reduced full color residual image or the full color residual image so that the noise-reduced full color residual image is scaled.

8. The method of claim 1 further including noise-reducing the noise-reduced full color fully processed image to produce an additionally noise-reduced full color fully processed image.

9. A computer storage medium having instructions stored therein for causing a computer to perform the method of claim 1.
